(19) United States
(12) Patent Application Publication
(10) Pub. No.: US 2026/0335818 A1
(43) Pub. Date: Oct. 29, 2026

(54) GAS DRYER

(71) Applicant: AGC ENGINEERING CO., LTD., Chiba-shi (JP)

(72) Inventor: Masato KAMADA, Chiba-shi (JP)

(73) Assignee: AGC ENGINEERING CO., LTD., Chiba-shi (JP)

(21) Appl. No.: 19/648,091

(22) Filed: Apr. 15, 2026

(30) Foreign Application Priority Data
Apr. 25, 2025 (JP) 2025-073094

(51) Int. Cl. B01D 53/26; B01D 53/22; B01D 63/02

(52) U.S. Cl. CPC B01D 53/268; B01D 63/02; B01D 2053/224; B01D 2257/80; B01D 2313/041; B01D 2313/13

(57) ABSTRACT

The present invention provides a gas dryer that can be reduced in size. The gas dryer of the present invention includes: a hollow fiber membrane having a cylindrical shape that surrounds a center axis aligned along a first direction and extends in the first direction; an outer tube having a cylindrical shape that extends in the first direction and accommodating therein a part of the hollow fiber membrane; a connector configured to hold the outer tube and the hollow fiber membrane; and a sealing part configured to seal between an inner circumferential surface of the connector and the hollow fiber membrane.

### TECHNICAL FIELD

The present invention relates to a gas dryer.

### BACKGROUND ART

A gas dryer is known in which a hollow fiber membrane is surrounded by an outer tube so that, in applications such as component analysis of gases (e.g., combustion gases generated from thermal power plants, exhaust gases emitted from vehicles, or the like), the gas is dehumidified by transferring water vapor in the gas flowing through the inside of the hollow fiber membrane into dry purge gas flowing through the space between the hollow fiber membrane and the outer tube (see, for example, Patent Document 1). The above-described gas dryer has: a tube connector body that holds the hollow fiber membrane and the outer tube; a tube connector joint member fixed to the tube connector body; and a flat plate-shaped sealing member that seals between the inner surface of the tube connector joint member and the hollow fiber membrane to suppress mixing of the purge gas into the gas.

### PRIOR ART DOCUMENTS

### Patent Documents

Patent Document 1: JP-A-2006-346635

### DISCLOSURE OF INVENTION

### Technical Problem

It has been difficult to reduce the size of the above-described gas dryer due to the configuration in which the flat plate-shaped sealing member seals between the hollow fiber membrane and the inner surface of the tube connector joint member secured to

In view of the above circumstances, it is an object of the present invention to provide a gas dryer that can be reduced in size.

### Solution to Problem

The present invention includes the following aspects.
[1] A gas dryer comprising: a hollow fiber membrane having a cylindrical shape that surrounds a center axis aligned along a first direction and extends in the first direction; an outer tube having a cylindrical shape that extends in the first direction and accommodating therein a part of the hollow fiber membrane; a connector configured to hold the outer tube and the hollow fiber membrane; and a sealing part configured to seal between an inner surface of the connector and the hollow fiber membrane.
[2] The gas dryer according to [1], wherein the connector comprises: a first pipe section extending toward an inner side in the first direction; a second pipe section extending toward an outer side in the first direction; and a third pipe section disposed between the first pipe section and the second pipe section in the first direction and extending in a second direction that intersects the first direction, wherein an end portion of the outer tube on the outer side in the first direction is located within the first pipe section, wherein an end portion of the hollow fiber membrane on the outer side in the first direction is located within the second pipe section, and wherein the sealing part seals between an inner surface of the second pipe section and the hollow fiber membrane.
[3] The gas dryer according to [2], wherein the sealing part comprises: a backup sleeve having an insertion portion inserted into the hollow fiber membrane from the end portion of the hollow fiber membrane and an annular portion connected to the insertion portion in the first direction and disposed outside the hollow fiber membrane; a seal ring having a cylindrical shape that extends in the first direction and disposed between the hollow fiber membrane and the inner surface of the second pipe section; and a sealing member having an annular shape that surrounds the center axis and configured to seal between the inner surface of the second pipe section and the seal ring, wherein the insertion portion has a cylindrical shape that surrounds the center axis and extends in the first direction, wherein an outer circumferential surface of the insertion portion is configured to expand outward in a radial direction about the center axis toward the outer side in the first direction, wherein an inner circumferential surface of the seal ring is configured to expand outward in the radial direction about the center axis toward the outer side in the first direction, and wherein the hollow fiber membrane is in contact with the outer circumferential surface of the insertion portion and the inner circumferential surface of the seal ring.
[4] The gas dryer according to [3], wherein the seal ring has a stepped surface provided on an outer circumferential surface thereof and facing the inner side in the first direction, and wherein the sealing member is disposed on the inner side in the first direction relative to the stepped surface and is brought into contact with the stepped surface in the first direction.
[5] The gas dryer according to [3] or [4], wherein the ratio of a distance between an inner surface of the third pipe section and the seal ring in the first direction, to a distance in the first direction between the inner surface of the third pipe section and an end of the second pipe section on the outer side in the first direction, is 20% or less.
[6] The gas dryer according to any one of [1] to [5], comprising two connectors, one of the connectors holding end portions of the outer tube and the hollow fiber membrane on one side in the first direction, and the other of the connectors holding end portions of the outer tube and the hollow fiber membrane on the other side in the first direction.
[7] The gas dryer according to any one of [1] to [6], wherein a first gas flows through the inside of the hollow fiber membrane, wherein a second gas flows through a space between the outer tube and the hollow fiber membrane, and wherein a water vapor pressure of the second gas is lower than a water vapor pressure of the first gas.

### ADVANTAGEOUS EFFECTS OF INVENTION

According to the present invention, it is possible to provide a gas dryer that can be reduced in size.

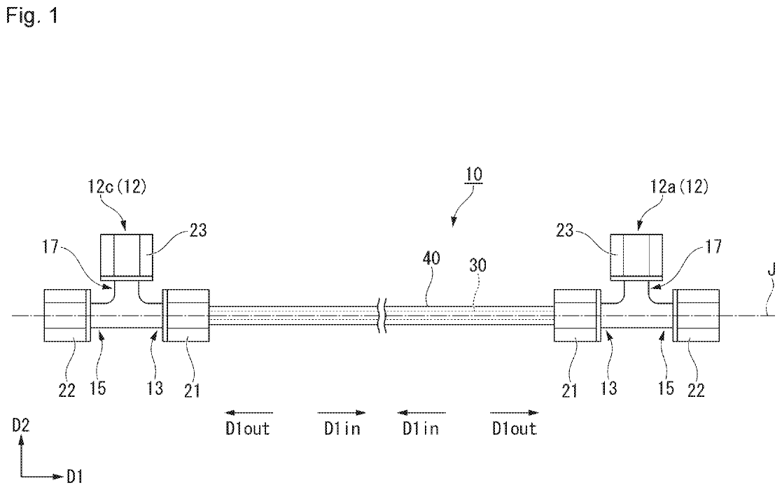

FIG. 1 is a side view of a gas dryer according to an embodiment of the present invention.

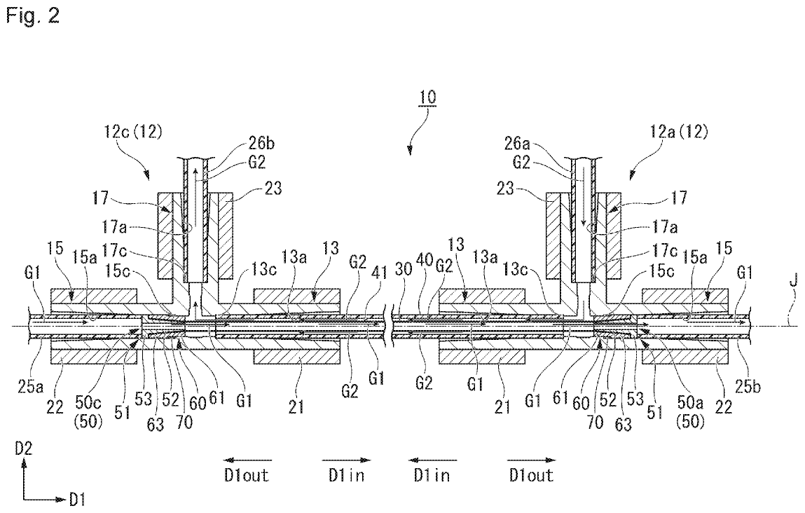

FIG. 2 is a cross-sectional view of the gas dryer according to the embodiment of the present invention.

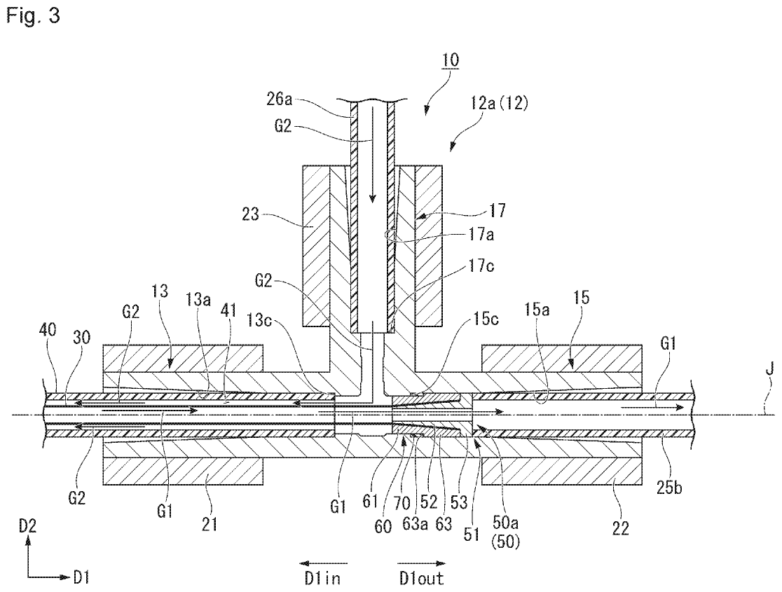

FIG. 3 is a first enlarged cross-sectional view of a part of the gas dryer according to the embodiment of the present invention.

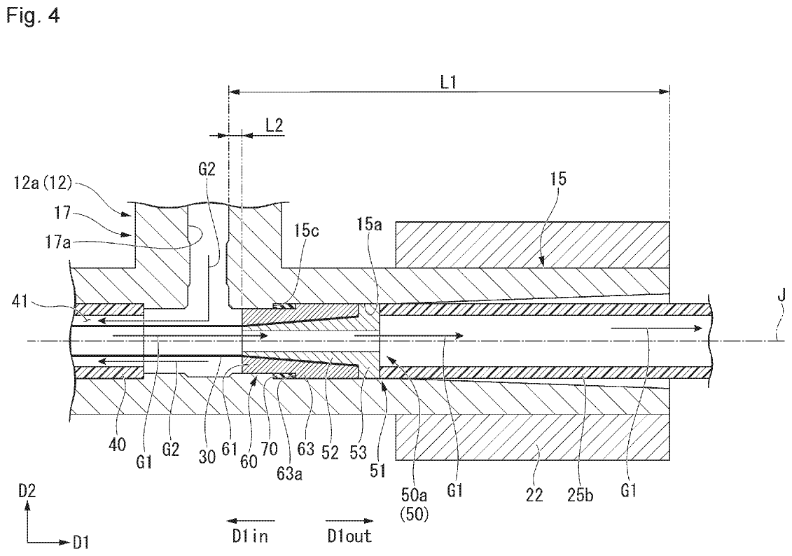

FIG. 4 is a second enlarged cross-sectional view of a part of the gas dryer according to the embodiment of the present invention.

### DESCRIPTION OF EMBODIMENTS

Hereinafter, one embodiment of the present invention will be described below with reference to the drawings. In the respective drawings, the same reference numerals are assigned to the same or corresponding components, and descriptions of such components may be omitted. The dimensions of the respective components illustrated in the drawings are merely examples and are not intended to limit the scope of the present invention. The present invention can be implemented with various changes and modifications without departing from the scope of the present invention. Furthermore, the scale and number of each component in the drawings may differ from the actual structure for the sake of clarity.

In each drawing, a first direction D1 is indicated as appropriate. In the present embodiment, the first direction D1 is a direction along which a center axis J is aligned and extends. The center axis J is a virtual axis. Further, the first direction D1 is a direction along which a hollow fiber membrane and an outer tube extend. In the following description, a side (+D1 side) toward which the arrow of the first direction D1 points is referred to as the “right side” or “one side in the first direction D1”; and a side (−D1 side) opposite to the side toward which the arrow of the first direction D1 points is referred to as the “left side” or “the other side in the first direction D1”. In the following description, a radial direction about the center axis J may be simply referred to as a

In each drawing, an outer side D1out in the first direction D1 and an inner side D1in in the first direction D1 are indicated as appropriate. The outer side D1out in the first direction D1 is a side facing an end of the hollow fiber membrane in the first direction D1. The inner side D1in in the first direction D1 is a side facing the center of the hollow fiber membrane in the first direction D1.

In each drawing, a second direction D2 is also indicated as appropriate. In the present embodiment, the second direction D2 is a direction orthogonal to the first direction D1. However, the second direction D2 does not necessarily have to be orthogonal to the first direction D1, and can be any direction that intersects the first direction D1. In the following description, a side toward which the arrow of the second direction D2 points (the +D2 side) is referred to as the “upper side”; and a side opposite to the side toward which the arrow of the second direction D2 points (the −D2 side) is referred to as the “lower side”. It should however be understood that: the directional terms such as right, left, upper and lower are merely used to describe the relative positional relationships of the respective components; and the actual arrangements and orientations of the respective components may be any other than those indicated by these directional terms.

FIG. 1 is a side view of a gas dryer 10 according to the present embodiment. FIG. 2 is a cross-sectional view of the gas dryer 10 according to the present embodiment. FIG. 3 is a first enlarged cross-sectional view of a part of the gas dryer 10 according to the present embodiment. FIG. 4 is a second enlarged cross-sectional view of a part of the gas dryer 10 according to the present embodiment.

The gas dryer 10 of the present embodiment is a dehumidifier connected to an analysis apparatus (not shown) that performs component analysis of first gas G1, such as combustion gas generated from a thermal power plant, exhaust gas emitted from vehicles or the like, and configured to remove water vapor from the first gas G1 to be supplied to the analysis apparatus. More specifically, the gas dryer 10 of the present embodiment dehumidifies the first gas G1 by, while allowing the first gas G1 to flow inside a hollow fiber membrane 30 and dry second gas G2 to flow outside the hollow fiber membrane 30, causing water vapor in the first gas G1 to penetrate through the hollow fiber membrane 30 to the outside of the hollow fiber membrane 30 and be absorbed into the dry second gas G2. As shown in FIG. 1, the gas dryer 10 includes connectors 12, nuts 21, 22 and 23, a hollow fiber membrane 30 and an outer tube 40. As shown in FIG. 2, the gas dryer 10 further includes sealing parts 50.

Each of the connectors 12 holds the outer tube 40 and the hollow fiber membrane 30 as shown in FIG. 1. As shown in FIG. 2, the connectors 12 have flow paths through which the first gas G1 and the second gas G2 flow, respectively. In the present embodiment, the connectors 12 are in the form of T-shaped fittings. In the present embodiment, the connectors 12 are made of a resin material. Alternatively, the connectors 12 may be made of a metal material. As shown in FIG. 2, each of the connectors 12 has a first pipe section 13, a second pipe section 15 and a third pipe section 17.

The first pipe section 13 has a circular cylindrical shape that surrounds the center axis J and extends toward the inner side D1in in the first direction D1. As shown in FIG. 3, the first pipe section 13 is open to the inner side D1in in the first direction D1. An end portion of the outer tube 40 on the outer side D1out in the first direction D1 is inserted into the first pipe section 13. Further, a portion of the hollow fiber membrane 30 on the outer side D1out in the first direction D1 is passed through the first pipe section 13. An external thread (not shown) is provided on an outer circumferential surface of the first pipe section 13. An internal thread is provided on an inner circumferential surface of the nut 21 and is brought into engagement with the external thread. By such thread engagement, the nut 21 is fixed to the first pipe section 13. The first pipe section 13 has a first inner surface 13a and a first abutment surface 13c.

The first inner surface 13a is an inner surface of the first pipe section 13. When viewed from the first direction D1, the first inner surface 13a has a substantially circular shape that surrounds the center axis J. The first abutment surface 13c is a stepped surface provided on the first inner surface 13a and facing the inner side D1in in the first direction D1. When viewed from the first direction D1, the first abutment surface 13c has a substantially circular annular shape that surrounds the center axis J.

The second pipe section 15 is disposed on the outer side D1out in the first direction D1 relative to the first pipe section 13. The second pipe section 15 has a circular cylindrical shape that surrounds the center axis J and extends toward the outer side D1out in the first direction D1. The second pipe section 15 is open to the outer side D1out in the first direction D1. The second pipe section 15 is connected to the first pipe section 13 in the first direction D1. The inside of the second pipe section 15 is in communication with the inside of the first pipe section 13. An end portion of the hollow fiber membrane 30 on the outer side D1out in the first direction D1 and the sealing part 50 are placed within the second pipe section 15. An external thread (not shown) is provided on an outer circumferential surface of the second pipe section 15. An internal thread is provided on an inner circumferential surface of the nut 22 and is brought into engagement with the external thread. By such thread engagement, the nut 22 is fixed to the second pipe section 15. The second pipe section 15 has a second inner surface 15a and a second abutment surface 15c.

The second inner surface 15a is an inner surface of the second pipe section 15. When viewed from the first direction D1, the second inner surface 15a has a substantially circular shape that surrounds the center axis J. The second abutment surface 15c is a stepped surface provided on the second inner surface 15a and facing the outer side D1out in the first direction D1. When viewed from the first direction D1, the second abutment surface 15c has a substantially circular annular shape that surrounds the center axis J.

The third pipe section 17 has a circular cylindrical shape that extends in the second direction D2. The third pipe section 17 is open to the upper side. The third pipe section 17 is disposed between the first pipe section 13 and the second pipe section 15 in the first direction D1. A lower end of the third pipe section 17 is connected to the first and second pipe sections 13 and 15. The inside of the third pipe section 17 is in communication with the inside of the first pipe section 13 and with the inside of the second pipe section 15. An external thread (not shown) is provided on an outer circumferential surface of the third pipe section 17. An internal thread is provided on an inner circumferential surface of the nut 23 and is brought into engagement with the external thread. By such thread engagement, the nut 23 is fixed to the third pipe section 17. The third pipe section 17 has a third inner surface 17a and a third abutment surface 17c.

The third inner surface 17a is an inner surface of the third pipe section 17. When viewed from the second direction D2, the third pipe section 17a has a substantially circular shape. The third abutment surface 17c is a stepped surface provided on the third inner surface 17a and facing the upper side. When viewed from the second direction D2, the third abutment surface 17c has a substantially circular annular shape.

As shown in FIG. 1, the gas dryer 10 has two connectors 12 including a first connector 12a and a second connector 12c. In the present embodiment, the first connector 12a and the second connector 12c have the same configuration. The first connector 12a and the second connector 12c may have different configurations. The first connector 12a and the second connector 12c are arranged spaced apart from each other in the first direction D1. As shown in FIG. 2, the first connector 12a and the second connector 12c are symmetrical to each other with respect to the second direction D2. In the following description, the first connector 12a may be referred to as one connector 12; and the second connector 12c may be referred to as the other connector 12. One connector 12 holds the end portions of the outer tube 40 and the hollow fiber membrane 30 on the right side (+D1 side), that is, one side in the first direction D1. The other connector 12 holds the end portions of the outer tube 40 and the hollow fiber membrane 30 on the left side (−D1 side), that is, the other side in the first direction D1.

The hollow fiber membrane 30 has a cylindrical shape that surrounds the center axis J and extends in the first direction D1. The hollow fiber membrane 30 is open to both sides in the first direction D1. The hollow fiber membrane 30 exhibits selective water vapor permeability to allow water vapor in the first gas G1 to permeate therethrough while suppressing permeation of the first gas G1 and the second gas G2. The right-side (+D1 side) portion of the hollow fiber membrane 30 is passed through the first pipe section 13 of the first connector 12a in the first direction D1. The left-side (−D1 side) portion of the hollow fiber membrane 30 is passed through the first pipe section 13 of the second connector 12c in the first direction D1. The right-side end portion of the hollow fiber membrane 30 is located within the second pipe section 15 of the first connector 12a. The left-side end portion of the hollow fiber membrane 30 is located within the second pipe section 15 of the second connector 12c. In other words, the end portion of the hollow fiber membrane 30 on the outer side D1out in the first direction D1 is located within the second pipe section 15. The first gas G1 flows through the inside of the hollow fiber membrane 30. In the present embodiment, the first gas G1 flows through the inside of the hollow fiber membrane 30 toward the right side.

The material of the hollow fiber membrane 30 is not particularly limited. Examples of the material of the hollow fiber membrane 30 include polysulfones, polyether sulfones, polyimides, polyetherimides, silicones, cellulose acetates, fluorinated ion exchange resins, polyvinylidene fluorides and polytetrafluoroethylenes.

With a view to achieving excellent selective water vapor permeability, polysulfones, polyether sulfones, polyimides, polyetherimides and fluorinated ion change resins are preferred as the material of the hollow fiber membrane 30. The material of the hollow fiber membrane 30 may be one type or two or more types. In the present embodiment, the outer diameter of the hollow fiber membrane 30 is approximately 1.3 mm; and the inner diameter of the hollow fiber membrane 30 is approximately 1.0 mm. However, the outer and inner diameters of the hollow fiber membrane 30 are not limited to those illustrated in the present embodiment.

The outer tube 40 has a cylindrical shape that surrounds the center axis J and extends in the first direction D1. In the present embodiment, the outer tube 40 has a circular cylindrical shape that extends in the first direction D1. The outer tube 40 is open to both sides in the first direction D1. In the present embodiment, the outer tube 40 is made of a resin material. Alternatively, the outer tube 40 may be made of a metal material. The inner diameter of the outer tube 40 is larger than the outer diameter of the hollow fiber membrane 30. The right-side (+D1 side) end portion of the outer tube 40 is inserted into the first pipe section 13 of the first connector 12a, and is fitted onto the first inner surface 13a of the first connector 12a. The left-side (−D1 side) end portion of the outer tube 40 is inserted into the first pipe section 13 of the second connector 12c, and is fitted onto the first inner surface 13a of the second connector 12c. Thus, the right-side end portion of the outer tube 40 is located within the first pipe section 13 of the first connector 12a; and the left-side end portion of the outer tube 40 is located within the first pipe section 13 of the second connector 12c. In other words, the end portion of the outer tube 40 on the outer side D1out in the first direction D1 is located within the first pipe section 13. The right-side end portion of the outer tuber 40 is brought into contact with the first abutment surface 13c of the first connector 12a in the first direction D1. This allows the positioning of the outer tube 40 relative to the first connector 12a in the first direction D1. The left-side end portion of the outer tube 40 is brought into contact with the first abutment surface 13c of the second connector 12c. This allows the positioning of the outer tube 40 relative to the second connector 12c in the first direction D1.

The hollow fiber membrane 30 is passed through the inside of the outer tube 40 in the first direction D1, with both end portions of the hollow fiber membrane 30 protruding from the outer tube 40 toward the outer sides D1out in the first direction D1. Thus, the outer tube 40 accommodates therein a part of the hollow fiber membrane 30. As shown in FIG. 3, the outer tube 40 and the hollow fiber membrane 30 face each other with a space left therebetween in the radial direction. In the following description, the space between the outer tube 40 and the hollow fiber membrane 30 is referred to as a passage 41. The second gas G2 flows through the passage 41. In other words, the second gas G2 flows through the space between the outer tube 40 and the hollow fiber membrane 30. In the present embodiment, the second gas G2 flows through the passage 41 toward the left side (−D1 side). In the present embodiment, the second gas G2 is dry purge gas. The water vapor pressure of the second gas G2 is lower than the water vapor pressure of the first gas G1.

The sealing part 50 seals between the inner surface of the connector 12 and the hollow fiber membrane 30. As shown in FIG. 2, the gas dryer 10 has two sealing parts 50 in the present embodiment. As shown in FIG. 3, one sealing part 50a is disposed inside the second pipe section 15 of the first connector 12a to seal between the second inner surface 15a and the right-side (+D1 side) end portion of the hollow fiber membrane 30. As shown in FIG. 2, the other sealing part 50c is disposed inside the second pipe section 15 of the second connector 12c to seal between the second inner surface 15a and the left-side (−D1 side) end portion of the hollow fiber membrane 30. In other words, the sealing part 50 seals between the inner surface of the second pipe section 15 and the hollow fiber membrane 30. In the present embodiment, these two sealing parts 50 are each symmetrical in shape with respect to the first direction D1. These sealing parts 50 have the same configuration for sealing between the second inner surface 15a and the end portion of the hollow fiber membrane 30. Thus, the configuration of one sealing part 50a and the configuration of the other sealing part 50c will be collectively described in more detail below. As shown in FIG. 4, the sealing part 50 has a backup sleeve 51, a seal ring 60 and a sealing member 70.

The backup sleeve 51 has a cylindrical shape that surrounds the center axis J and extends in the first direction D1. In the present embodiment, the backup sleeve 51 is made of a resin material. Examples of the material constituting the backup sleeve 51 include polypropylenes and polyvinylidene fluorides. The backup sleeve 51 includes an insertion portion 52 and an annular portion 53.

The insertion portion 52 has a substantially circular cylindrical shape that surrounds the center axis J and extends in the first direction D1. The insertion portion 52 is inserted into the hollow fiber membrane 30 from the end portion of the hollow fiber membrane 30. When viewed from the first direction D1, an inner circumferential surface of the insertion portion 52 has a substantially circular shape. The inner diameter of the insertion portion 52 is substantially uniform in the first direction D1. An outer circumferential surface of the insertion portion 52 has a tapered shape that expands outwardly in the radial direction about the center axis J toward the outer side D1out in the first direction D1 (e.g., a tapered shape with its radial dimension gradually increasing toward the outer side D1out in the first direction D1). The hollow fiber membrane 30 is brought into contact with the outer circumferential surface of the insertion portion 52. As a result, the end portion of the hollow fiber membrane 30 on the outer side D1out in the first direction D1 is spread in a flared shape.

The annular portion 53 has an annular shape that surrounds the center axis J. The annular portion 53 is disposed on the outer side D1out in the first direction D1 relative to each of the insertion portion 52 and the hollow fiber membrane 30. In other words, the annular portion 53 is disposed outside the hollow fiber membrane 30. The annular portion 53 is connected to the insertion portion 52 in the first direction D1. The outer diameter of the annular portion 53 is larger than the outer diameter of the insertion portion 52. An outer circumferential surface of the annular portion 53 is fitted onto the second inner surface 15a. As a result, the backup sleeve 51 is fixed to the connector 12. The end portion of the hollow fiber membrane 30 is brought into contact with the annular portion 53. This allows the positioning of the hollow fiber membrane 30 relative to the connector 12 in the first direction D1.

The seal ring 60 has a cylindrical shape that surrounds the center axis J, the hollow fiber membrane 30 and the insertion portion 52 from the radially outer side and extends in the first direction D1. The seal ring 60 is disposed between the hollow fiber membrane 30 and the second pipe section 15 in the radial direction. The seal ring 60 faces the insertion portion 52, with the hollow fiber membrane 30 sandwiched therebetween. In the present embodiment, the seal ring 60 is made of a resin material. Examples of the material constituting the seal ring 60 include polypropylenes and polyvinylidene fluorides. The seal ring 60 includes a body portion 61 and an outer annular portion 63.

The body portion 61 has a substantially circular cylindrical shape that surrounds the center axis J and extends in the first direction D1. The body portion 61 is an inner portion of the seal ring 60 in the radial direction. The body portion 61 faces the insertion portion 52, with the hollow fiber membrane 30 sandwiched therebetween. A part of an outer circumferential surface of the body portion 61, located on the inner side D1in in the first direction D1 relative to the second abutment surface 15c, is fitted onto the second inner surface 15a. As a result, the seal ring 60 is fixed to the connector 12. An inner circumferential surface of the body portion 61 has a tapered shape that expands outward in the radial direction about the center axis J toward the outer side D1out in the first direction D1 (e.g., a tapered shape with its radial dimension gradually increasing toward the outer side D1out in the first direction D1). In other words, the inner circumferential surface of the seal ring 60 has a tapered shape that expands outward in the radial direction about the center axis J toward the outer side D1out in the first direction D1. The hollow fiber membrane 30 is brought into contact with the inner circumferential surface of the body portion 61. In other words, the hollow fiber membrane 30 is brought into contact with the inner circumferential surface of the seal ring 60. As described above, the hollow fiber membrane 30 is also brought into contact with the outer circumferential surface of the insertion portion 52. By these contacts, the hollow fiber membrane 30 is held between and fitted onto the backup sleeve 51 and the seal ring 60. The hollow fiber membrane 30 is thus fixed to the connector 12 via the backup sleeve 51 and the seal ring 60. Since the hollow fiber membrane 30 can be fixed to the connector 12 without using an adhesive such as an epoxy resin in the present embodiment, it is possible to suppress the elution of the adhesive components into the first gas G1. This enables accurate component analysis of the first gas G1 by the analysis apparatus (not shown).

Furthermore, as described above, the outer circumferential surface of the insertion portion 52 is tapered to expand outward in the radial direction toward the outer side D1out in the first direction D1; and the inner circumferential surface of the seal ring 60 is tapered to expand outward in the radial direction toward the outer side D1out in the first direction D1. Since the hollow fiber membrane 30 is held between and fitted onto the insertion portion 52 and the seal ring 60, a clamping force is exerted on the hollow fiber membrane 30 in a direction inclined from the first direction toward the radial direction. Thus, the fall-off of the hollow fiber membrane 30 from the sealing part 50 can be effectively suppressed.

The outer annular portion 63 has a substantially circular annular shape that surrounds a part of the body portion 61 on the outer side D1out in the first direction D1. The outer annular portion 63 is connected to the body portion 61 in the radial direction. The outer annular portion 63 is fitted onto the second inner surface 15a. As a result, the seal ring 60 is fixed to the connector 12. The outer annular portion 63 has a stepped surface 63a. The stepped surface 63a is a part of the outer surface of the outer annular portion 63 facing the inner side D1in in the first direction D1. The stepped surface 63a is a part of the outer circumferential surface of the seal ring 60. In other words, the stepped surface 63a is provided on the outer circumferential surface of the seal ring 60. The stepped surface 63a faces the second abutment surface 15c, with a space left therebetween in the first direction D1.

The sealing member 70 has an annular shape that surrounds the center axis J. In the present embodiment, a gasket or a packing can be used as the sealing member 70. The sealing member 70 surrounds each of the body portion 61, the hollow fiber membrane 30 and the insertion portion 52 from the radially outer side. The sealing member 70 is disposed on the inner side D1in in the first direction D1 relative to the stepped surface 63a. More specifically, the sealing member 70 is disposed between the second abutment surface 15c and the stepped surface 63a in the first direction D1. The sealing member 70 is brought into contact with both of the second abutment surface 15c and the stepped member 63a in the first direction D1. This allows the positioning of the sealing member 70 relative to the connector 12 in the first direction D1. The sealing member 70 is disposed between the body portion 61 and the second inner surface 15a in the radial direction. The sealing member 70 is brought into contact with both of the body portion 61 and the second inner surface 15a, thereby sealing between the inner surface of the second pipe section 15 and the seal ring 60. Further, the sealing member 70 seals between the second inner surface 15a and the hollow fiber member 30 via the seal ring 60. Thus, the sealing part 50 seals between the inner surface of the second pipe section 15 and the hollow fiber membrane 30. In other words, the sealing part 50 seals between the inner surface of the connector 12 and the hollow fiber membrane 30.

Assuming that: a distance in the first direction D1 between the third inner surface 17a (that is, the inner surface of the third pipe section 17) and the end of the second pipe section 15 on the outer side D1out in the first direction D1 is a first distance L1; and a distance between the third inner surface 17a and the seal ring 60 in the first direction D1 is a second distance L2, the ratio of the second distance L2 to the first distance L1 is 20% or less in the present embodiment. Through such dimensional control, the distance between the inside of the third pipe section 17 and the seal ring 60 in the first direction D1 can be shortened. The ratio of the second distance L2 to the first distance L1 is preferably 10% or less.

As shown in FIG. 2, a first tube 25a is attached to the second pipe section 15 of the second connector 12c. An end portion of the first tube 25a is brought into contact with the annular portion 53 of the backup sleeve 51 in the first direction D1. This allows the positioning of the first tube 25a relative to the second connector 12c. The first gas G1, such as combustion gas generated from a thermal power plant, exhaust gas emitted from vehicles or the like, flows into the second pipe section 15 of the second connector 12c through the first tube 25a. In other words, the first gas G1 is supplied to the gas dryer 10 through the first tube 25a.

A second tube 25b is attached to the second pipe section 15 of the first connector 12a. The second tube 25b connects the second pipe section 15 of the first connector 12a to the analysis apparatus (not shown). As shown in FIG. 3, an end portion of the second tube 25b is brought into contact with the annular portion 53 of the backup sleeve 51 in the first direction D1. This allows the positioning of the second tube 25b relative to the first connector 12a. The first gas G1 from which water vapor has been removed during flow inside the hollow fiber membrane 30 flows into the second tube 25b. The first gas G1 flowing into the second tube 25b is supplied to the analysis apparatus (not shown) through the second tube 25b.

A third tube 26a is attached to the third pipe section 17 of the first connector 12a. An end portion of the third tube 26a is brought into contact with the third abutment surface 17c in the second direction D2. This allows the positioning of the third tube 26a relative to the first connector 12a. The dry second gas G2 flows into the third pipe section 17 of the first connector 12a through the third tube 26a. In other words, the second gas G2 is supplied to the gas dryer 10 through the third tube 26a.

As shown in FIG. 2, a fourth tube 26b is attached to the third pipe section 17 of the second connector 12c. An end portion of the fourth tube 26b is brought into contact with the third abutment surface 17c in the second direction D2. This allows the positioning of the fourth tube 26b relative to the second connector 12c. The second gas G2 which has absorbed water vapor removed from the first gas G1 during flow inside the passage 41 flows into the fourth tube 26b. The second gas G2 flowing into the fourth tube 26b is discharged out of the gas dryer 10 through the fourth tube 26b.

As described above, the first gas G1 containing water vapor flows into the second pipe section 15 of the second connector 12c through the first tube 25a. The first gas G1 flowing into the second pipe section 15 of the second connector 12c flows into the hollow fiber membrane 30 from the left-side end of the hollow fiber membrane 30, and then, flows through the inside of the hollow fiber membrane 30 toward the right side (+D1 side). On the other hand, the dry second gas G2 flows into the third pipe section 17 of the first connector 12a through the third tube 26a as described above. As shown in FIG. 4, the second gas G2 flowing into the third pipe section 17 of the first connector 12a flows into the passage 41, that is, the space between the outer tube 40 and the hollow fiber membrane 30 and then flows through the passage 41 toward the left side (−D1 side). As described above, the sealing part 50 seals between the second inner surface 15a and the hollow fiber membrane 30. The leakage of the second gas G2 to the right side of the sealing part 50 can be thus suppressed, thereby preventing mixing of the second gas G2 into the first gas G1. This enables accurate component analysis of the first gas G1 by the analysis apparatus (not shown).

In the present embodiment, the ratio of the second distance L2 to the first distance L1 is 20% or less as described above. Through such dimensional control, the distance between the inside of the third pipe section 17 and the seal ring 60 in the first direction D1 can be shortened, thereby decreasing the flow rate of the second gas G2 from the third pipe section 17 into the second pipe section 15 and increasing the flow rate of the second gas G2 from the third pipe section 17 into the passage 41. Further, the areas of accumulation of the second gas G2 within the connector 12 can be minimized as much as possible, and thus, the dehumidification performance of the gas dryer 10 can be suitably enhanced.

As shown in FIG. 2, the first gas G1 containing water vapor flows through the inside of the hollow fiber membrane 30 toward the right side (+D1 side), whereas the dry second gas G2 flows through the passage 41 toward the left side (−D1 side). As described above, the water vapor pressure of the second gas G2 is lower than the water vapor pressure of the first gas G1. Due to the selective water vapor permeability of the hollow fiber membrane 30, water vapor in the first gas G1 flowing through the inside of the hollow fiber membrane 30 penetrates through the hollow fiber membrane 30 and is absorbed into the second gas G2. The first gas G1 can be thus suitably dehumidified while flowing through the inside of the hollow fiber membrane 30.

The second gas G2 which has absorbed water vapor removed from the first gas G1 during flow inside the passage 41 is discharged to the outside of the gas dryer 10 through the fourth tube 26b. Accordingly, water vapor which has been contained in the first gas G1 is discharged to the outside of the gas dryer 10 through the fourth tube 26b. Further, the first gas G1 from which water vapor has been removed through the hollow fiber membrane 30 is discharged to the outside of the hollow fiber membrane 30 from the right-side (+D1 side) end portion of the hollow fiber membrane 30, and then, supplied to the analysis apparatus (not shown) through the second tube 25b. Since the dehumidified first gas G1 is supplied to the analysis apparatus (not shown), the analysis apparatus can perform accurate component analysis of the first gas G1.

According to the present embodiment, the gas dryer 10 is provided including: the hollow fiber membrane 30 having a cylindrical shape that surrounds the center axis J aligned along the first direction D1 and extends in the first direction D1; the outer tube 40 having a cylindrical shape that extends in the first direction D1 and accommodating therein a part of the hollow fiber membrane 30; the connector 12 configured to hold the outer tube 40 and the hollow fiber membrane 30; and the sealing part 50 configured to seal between the inner surface of the connector 12 and the hollow fiber membrane 30. With this configuration, the gas dryer 10 can be reduced in size in the first direction D1 as compared to a gas dryer of the type in which a sealing part seals between the hollow fiber membrane 30 and the inner surface of a member such as a nut disposed on the outer side D1out in the first direction D1 relative to the connector 12 and secured to the connector 12. It is therefore possible in the present embodiment to achieve a size reduction of the gas dryer 10. Furthermore, the areas of accumulation of the second gas G2 within the connector 12 can be minimized as much as possible. It is thus possible to suitably enhance the dehumidification performance of the gas dryer 10.

Since the above-mentioned member such as nut is not required in the present embodiment, it is possible to suppress an increase in the number of component parts of the gas dryer 10 and thereby suppress increases in the manufacturing cost and workload for the gas dryer 10.

In the present embodiment, the connector 12 includes: the first pipe section 13 extending toward the inner side D1in in the first direction D1; the second pipe section 15 extending toward the outer side D1out in the first direction D1; and the third pipe section 17 disposed between the first pipe section 13 and the second pipe section 15 in the first direction D1 and extending in the second direction D2; the end portion of the outer tube 40 on the outer side D1out in the first direction D1 is located within the first pipe section 13; the end portion of the hollow fiber membrane 30 on the outer side D1out in the first direction D1 is located within the second pipe section 15; and the sealing part 15 seals between the second inner surface 15a, that is, the inner surface of the second pipe section 15 and the hollow fiber membrane 30. With this configuration, as shown in FIG. 4, the sealing part 50 can separate the inside of the third gas pipe 17 and the passage 41 through which the second gas G2 flows from the inside of the second pipe section 15 and the inside of the hollow fiber membrane 30 through which the first gas G1 flows. Consequently, it is possible to prevent mixing of the second gas G2 into the first gas G1 so that the analysis apparatus (not shown) can perform accurate component analysis of the first gas G1.

In the present embodiment, the sealing part 50 includes: the backup sleeve 51 having the insertion portion 52 inserted into the hollow fiber membrane 30 from the end portion of the hollow fiber membrane 30 and the annular portion 53 connected to the insertion portion 52 in the first direction D1 and disposed outside the hollow fiber membrane 30; the seal ring 60 having a cylindrical shape that extends in the first direction D1 and disposed between the hollow fiber membrane 30 and the second inner surface 15a, that is, the inner surface of the second pipe section 15; and the sealing member 70 having an annular shape that surrounds the center axis J and configured to seal between the second inner surface 15a and the seal ring 60. Here, the insertion portion 52 has a cylindrical shape that surrounds the center axis J and extends in the first direction D1; the outer circumferential surface of the insertion portion 52 is configured to expand outward in the radial direction toward the outer side D1out in the first direction D1; the inner circumferential surface of the seal ring 60 is configured to expand outward in the radial direction toward the outer side D1out in the first direction; and the hollow fiber membrane 30 is in contact with the outer circumferential surface of the insertion portion 52 and the inner circumferential surface of the seal ring 60. With this configuration, the hollow fiber membrane 30 is held between and fitted onto the insertion portion 52 and the seal ring 60 so that a clamping force is exerted on the hollow fiber membrane 30 in a direction inclined from the first direction D1 toward the radial direction as described above. Thus, the fall-off of the hollow fiber membrane 30 from the sealing part 50 can be effectively suppressed.

In the present embodiment, the stepped surface 63a is provided on the outer circumferential surface of the seal ring 60 so as to face the inner side D1in in the first direction D1; and the sealing member 70 is disposed on the inner side D1in in the first direction D1 relative to the stepped surface 63a and is brought into contact with the stepped surface 63a in the first direction D1. With this configuration, the stepped surface 63a can suppress movement of the sealing member 70 toward the outer side D1out in the first direction D1, and as a result, the sealing member 70 can properly seal between the second inner surface 15a and the sealing ring 60. It is consequently possible to effectively prevent mixing of the second gas G2 into the first gas G1 so that the analysis apparatus (not shown) can perform more accurate component analysis of

In the present embodiment, the ratio of the second distance L2 (the distance between the inner surface of the third pipe section 17 and the seal ring 60 in the first direction D1) to the first distance L1 (the distance in the first direction D1 between the inner surface of the third pipe section 17 and the end of the second pipe section 15 on the outer side D1out in the first direction D1) is set to be 20% or less. With this configuration, the distance between the inside of the third pipe section 17 and the seal ring 60 in the first direction D1 can be shortened as described above, thereby decreasing the flow rate of the second gas G2 from the third pipe section 17 into the second pipe section 15 and increasing the flow rate of the second gas G2 from the third pipe section 17 into the passage 41. As a result, the amount of water vapor transferred from the first gas G1 flowing through the inside of the hollow fiber membrane 30 into the second gas G2 flowing through the passage 41 can be effectively increased. Further, the areas of accumulation of the second gas G2 within the connector 12 can be minimized as much as possible, and thus, the dehumidification performance of the gas dryer 10 can be suitably enhanced.

In the present embodiment, the gas dryer 10 has two connectors 12. One connector 12, referred to as the first connector 12a, holds the end portions of the outer tube 40 and the hollow fiber membrane 30 on the right side (+D1 side), that is, one side in the first direction D1. The other connector 12, referred to as the second connector 12c, holds the end portions of the outer tube 40 and the hollow fiber membrane 30 on the left side (−D1 side), that is, the other side in the first direction D1. As described above, one sealing part 50a seals between the second inner surface 15a of the first connector 12a and the hollow fiber membrane 30; and the other sealing part 50c seals between the second inner surface 15a of the second connector 12c and the hollow fiber membrane 30. With this configuration, the gas dryer 10 can be reduced in size in the first direction D1 as compared to a gas dryer of the type in which each sealing part seals between the hollow fiber membrane 30 and the inner surfaces of a member such as a nut disposed on the outer side D1out in the first direction D1 relative to each connector 12 and secured to each connectors 12. It is therefore possible in the present embodiment to suitably achieve a size reduction of the gas dryer 10. Furthermore, the areas of accumulation of the second gas G2 within the connector 12 can be minimized as much as. It is thus possible to suitably enhance the dehumidification performance of the gas dryer 10.

In the present embodiment, the first gas G1 flows through the inside of the hollow fiber membrane 30; the second gas G2 flows through the passage 41, that is, the space between the outer tube 40 and the hollow fiber membrane 30, and the water vapor pressure of the second gas G2 is lower than the water vapor pressure of the first gas G1. As described above, due to the selective water vapor permeability of the hollow fiber membrane 30, water vapor in the first gas G1 flowing through the inside of the hollow fiber membrane 30 permeates through the hollow fiber membrane 30 and is absorbed into the second gas G2. The first gas G1 can be suitably dehumidified and, with the supply of the resulting dry first gas G1, the analysis apparatus (not shown) can perform accurate component analysis of the first gas G1.

Although the embodiment of the present invention has been described above, the features and combinations thereof illustrated in the above-described embodiment are merely examples; and additions, omissions, substitutions and other modifications of the features are possible within the range that does not depart from the scope of the present invention. The present invention is by no means restricted to the above-described embodiment.

The number of hollow fiber membranes in the gas dryer is not limited to that illustrated in the present embodiment. The gas dryer may be provided with a plurality of hollow fiber membranes. In such a case, the hollow fiber membranes show an increased surface area, thereby increasing the amount of water vapor absorbed into the second gas G2. It is thus possible to enhance the dehumidification performance of the gas dryer.

The entire disclosure of Japanese Patent Application No. 2025-073094 filed on Apr. 25, 2025 including specification, claims, drawings and summary is incorporated herein by reference in its entirety.

### REFERENCE SYMBOLS

10: Gas dryer
12: Connector
13: First pipe section
15: Second pipe section
17: Third pipe section
30: Hollow fiber membrane
40: Outer tube
50: Sealing part
51: Backup sleeve
52: Insertion portion
53: Annular portion
60: Seal ring
63a: Stepped surface
70: Sealing member
D1: First direction
D1in: Inner side in first direction
D1out: Outer side in first direction
D2: Second direction
G1: First gas
G2: Second gas
J: Center axis

What is claimed is:

1. A gas dryer comprising:
a hollow fiber membrane having a cylindrical shape that surrounds a center axis aligned along a first direction and extends in the first direction;
an outer tube having a cylindrical shape that extends in the first direction and accommodating therein a part of the hollow fiber membrane;
a connector configured to hold the outer tube and the hollow fiber membrane; and
a sealing part configured to seal between an inner surface of the connector and the hollow fiber membrane ..

2. The gas dryer according to claim 1,
wherein the connector comprises: a first pipe section extending toward an inner side in the first direction; a second pipe section extending toward an outer side in the first direction; and a third pipe section disposed between the first pipe section and the second pipe section in the first direction and extending in a second direction that intersects the first direction,
wherein an end portion of the outer tube on the outer side in the first direction is located within the first pipe section,
wherein an end portion of the hollow fiber membrane on the outer side in the first direction is located within the second pipe section, and
wherein the sealing part seals between an inner surface of the second pipe section and the hollow fiber membrane.

3. The gas dryer according to claim 2,
wherein the sealing part comprises:
a backup sleeve having an insertion portion inserted into the hollow fiber membrane from the end portion of the hollow fiber membrane and an annular portion connected to the insertion portion in the first direction and disposed outside the hollow fiber membrane;
a seal ring having a cylindrical shape that extends in the first direction and disposed between the hollow fiber membrane and the inner surface of the second pipe section; and
a sealing member having an annular shape that surrounds the center axis and configured to seal between the inner surface of the second pipe section and the seal ring,
wherein the insertion portion has a cylindrical shape that surrounds the center axis and extends in the first direction,
wherein an outer circumferential surface of the insertion portion is configured to expand outward in a radial direction about the center axis toward the outer side in the first direction,
wherein an inner circumferential surface of the seal ring is configured to expand outward in the radial direction about the center axis toward the outer side in the first direction, and
wherein the hollow fiber membrane is in contact with the outer circumferential surface of the insertion portion and the inner circumferential surface of the seal ring.

4. The gas dryer according to claim 3,
wherein the seal ring has a stepped surface provided on an outer circumferential surface thereof and facing the inner side in the first direction, and
wherein the sealing member is disposed on the inner side in the first direction relative to the stepped surface and is brought into contact with the stepped surface in the first direction.

5. The gas dryer according to claim 3, wherein the ratio of a distance between an inner surface of the third pipe section and the seal ring in the first direction, to a distance in the first direction between the inner surface of the third pipe section and an end of the second pipe section on the outer side in the first direction, is 20% or less.

6. The gas dryer according to claim 1, comprising two connectors,
one of the connectors holding end portions of the outer tube and the hollow fiber membrane on one side in the first direction, and
the other of the connectors holding end portions of the outer tube and the hollow fiber membrane on the other side in the first direction.

7. The gas dryer according to claim 1,
wherein a first gas flows through the inside of the hollow fiber membrane,
wherein a second gas flows through a space between the outer tube and the hollow fiber membrane, and
wherein a water vapor pressure of the second gas is lower than a water vapor pressure of the first gas.
